(19) United States
(12) Patent Application Publication
(10) Pub. No.: US 2018/0014502 A1
(43) Pub. Date: Jan. 18, 2018

(54) Multifunction Pet Carrier

(71) Applicant: O'Shaughnessy Holding Company, LLC, Eden Prairie, MN (US)

(72) Inventors: Michael L. O'Shaughnessy, Eden Prairie, MN (US); Douglas Patton, Irvine, CA (US)

(21) Appl. No.: 15/248,653

(22) Filed: Aug. 26, 2016

Related U.S. Application Data
(60) Provisional application No. 62/362,932, filed on Jul. 15, 2016.

(51) Int. Cl. A01K 1/02; B62B 1/26; A01K 1/035; A01K 27/00

(52) U.S. Cl. CPC A01K 1/0245; A01K 27/003; B62B 1/26; A01K 1/0272; A01K 1/0356; B62B 2202/42

(57) ABSTRACT

Systems, devices, and methods for a collapsible pet carrier are provided. The collapsible pet carrier includes a top panel, a bottom panel, and two side walls that are hingeably coupled with the top and bottom panel. Each of the side walls includes an upper side wall, a bottom side wall, a hinge that allows folding of the side wall. The pet carrier also includes two end portions. In an expanded configuration, the hinges are positioned at an essentially 180° angle such that the upper side wall and a bottom side wall are essentially planar. In the collapsed configuration, hinges are positioned at an angle of less than 30° such that the hinges subtend toward the opposing side wall.

This application claims priority to our U.S. provisional patent application with the Ser. No. 62/362932 filed Jul. 15, 2016 which is incorporated by reference herein in its entirety.

### FIELD OF THE INVENTION

The field of the inventive subject matter is carriers for pets and other animals.

### BACKGROUND

The background description includes information that may be useful in understanding the present invention. It is not an admission that any of the information provided herein is prior art or relevant to the presently claimed invention, or that any publication specifically or implicitly referenced is prior art.

Pet carriers can provide a safe and convenient way to transport pets for veterinary visits or while traveling. Such carriers generally provide an appropriately sized compartment, with an access door and a handle or similar arrangement to facilitate transport. While a pet carrier necessarily needs to be sized to provide both comfort and safety for the pet, such dimension can make the carrier unwieldy when stored or otherwise not in use.

Some manufacturers have addressed this issue by constructing pet carriers of pliable material, such as textiles. Portions of such carriers can be stiffened or contain stiffening panels to provide a degree of structure while still permitting a user to fold or compress the carrier when not in use. The use of such materials, however, necessarily limits the size and/or weight of the animal for which they can be used and can only provide limited protection of a pet within such a carrier. In addition, such materials are not readily cleaned when soiled. Finally, many pet species (notably large birds) have little difficulty in defeating a textile barrier.

Many commercial pet carriers are constructed of rigid materials arranged in a “clamshell” design, providing a lower half and an upper half that are connected by various reversible means (for example, latches, threaded posts, etc.) that permit a user to disassemble an unused carrier for storage. Such disassembly, however, necessitates storage of multiple, separate items, and generally only reduces the storage space requirements by less than half.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for collapsible pet carriers that can provide a stable, safe, and protective enclosure for pet animals of various sizes while permitting simple and straightforward folding and assembly.

### SUMMARY OF THE INVENTION

The inventive subject matter provides apparatus, systems and methods of a pet carrier that is configured to collapse into a flat, compact, and readily transportable form factor. Such a pet carrier can be quickly and easily unfolded or otherwise expanded to provide a stable and safe carrier for a pet. The pet carrier can be provided in different sizes to accommodate different companion animals, with different sizes having different feature sets as determined by their dimensions.

One aspect of the inventive subject matter includes a collapsible pet carrier. The collapsible pet carrier includes a top panel and a bottom panel, with the bottom panel coupled to the top panel by first and second sidewalls. The first sidewall preferably includes a first edge coupled to the top panel, a second edge coupled to the bottom panel, a third edge that is parallel to the first edge, a fourth edge that opposes the third edge, and a first hinge region interposed between the third and fourth edges. The second sidewall includes a fifth edge coupled to the top panel, a sixth edge coupled to the bottom panel, a seventh edge that is parallel to the fifth edge, an eighth edge that opposes the seventh edge, and a second hinge region interposed between the seventh and eighth edges. In a preferred embodiment, the second sidewall opposes the first sidewall, and the top and bottom panels and the first and second sidewalls collectively define a primary structure having a first end and a second end.

In some embodiments, the pet carrier further includes a first end portion and a second end portion. The first end portion is positionable at the first end and the second end portion is positionable at the second end. The first end portion includes an aperture and a barrier (e.g., a gate or door) configured to reversibly cover the aperture.

The pet carrier forms an expanded configuration when the first hinge region is positioned at an essentially 180° angle such that the first side wall portion is essentially planar, the second hinge region is positioned at an essentially 180° angle such that the second side wall portion is essentially planar, the first and second end portions are folded upwardly to lie adjacent against the top panel.

To collapse the carrier, the first and second end portions are rotated inwardly about their respective pivot points. The first and second side walls can then collapse inwardly toward one another about a central hinge of each side wall. The pet carrier portion forms a collapsed configuration wherein the first hinge region is positioned at an angle of less than 30° such that the first hinge region subtends towards the second side wall, the second hinge region is position at an angle of less than 30° such that the second hinge region subtends towards the first side wall, and the first end portion and second end portion are approximately parallel to and interposed between the first horizontal portion and the second horizontal portion.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A shows a perspective view of one embodiment of a pet carrier in an expanded configuration.

FIG. 1B shows a top view of one embodiment of a pet carrier in an expanded configuration.

FIG. 1C shows a side view of a side wall of one embodiment of a pet carrier transitioning in an expanded configuration.

FIG. 1D shows a side view of an end portion of one embodiment of a pet carrier in an expanded configuration.

FIG. 1E shows a perspective view of another embodiment of a pet carrier in an expanded configuration.

FIG. 2A shows a perspective view of one embodiment of a pet carrier transitioning from an expanded configuration to a collapsed configuration.

FIG. 2B shows another perspective view of one embodiment of a pet carrier transitioning from an expanded configuration to a collapsed configuration.

FIG. 2C shows a still another perspective view of one embodiment of a pet carrier transitioning from an expanded configuration to a collapsed configuration.

FIG. 2D shows a still another perspective view of one embodiment of a pet carrier transitioning from an expanded configuration to a collapsed configuration and a latch mechanism.

FIG. 3A shows a perspective view of one embodiment of a pet carrier in a collapsed configuration.

FIG. 3B shows a top view of one embodiment of a pet carrier in a collapsed configuration.

FIG. 3C shows a side view of a side wall of one embodiment of a pet carrier in a collapsed configuration.

FIG. 3D shows a side view of an end portion of one embodiment of a pet carrier in a collapsed configuration.

FIG. 4A illustrates projections from a side view of one embodiment of a pet carrier.

FIG. 4B illustrates projections from a top view of one embodiment of a pet carrier.

FIG. 5A shows one exemplary lock mechanism for one embodiment of a pet carrier.

FIG. 5B shows an engaging mechanism of the lock mechanism of FIG. 5A.

FIG. 6 shows a perspective view of one embodiment of a pet carrier that can be used as a dolly.

FIG. 7 shows a use example of one embodiment of a pet carrier that can be used as a dolly.

FIG. 8 shows another use example of one embodiment of a pet carrier that can be used as a dolly.

FIG. 9 shows a top view of one embodiment of a pet carrier with accessory bag.

FIGS. 10A-C show one exemplary latching system.

FIGS. 11A-B show another exemplary latching system.

FIGS. 12A-B show still another exemplary latching system.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, the terms “coupled to” and “coupled with” are used euphemistically in a networking context to mean “communicatively coupled with” where two or more devices are configured to exchange data (e.g., uni-directionally, bi-directionally, peer-to-peer, etc.) with each other possibly via one or more intermediary devices.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

In some embodiments, the numbers expressing quantities of properties such as dimensions used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One should appreciate that the disclosed devices, methods, and systems provide many advantageous technical effects including provision of a rigid or partially rigid pet carrier that can be easily stored and/or transported in a compact, folded state while also being simple to unfold or expand for use.

One aspect of the inventive subject matter includes a collapsible pet carrier, which a user can conveniently change its configuration from an expanded configuration when in use, to a collapsed configuration when not in use, and thereby decrease its volume by greater than 75%.

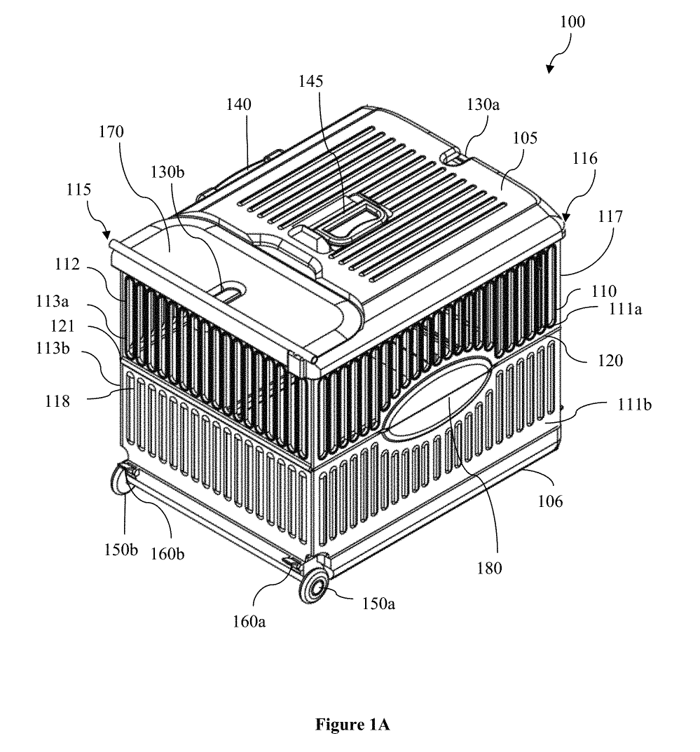

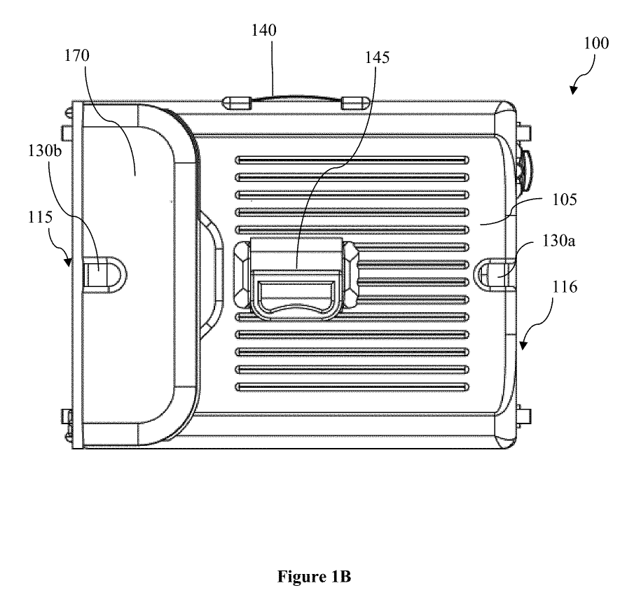

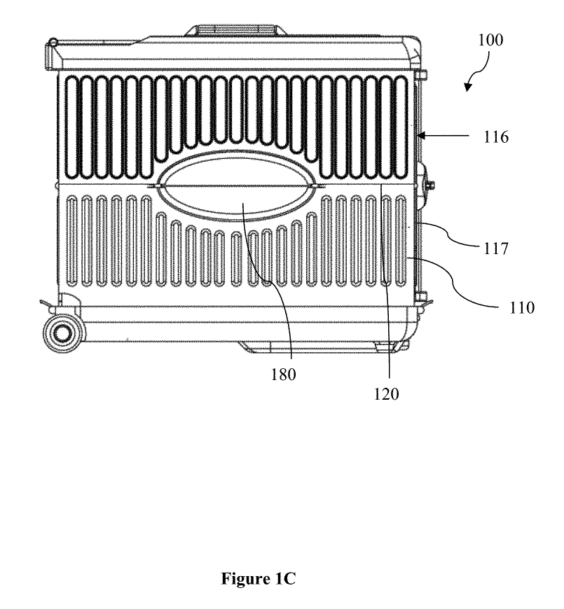

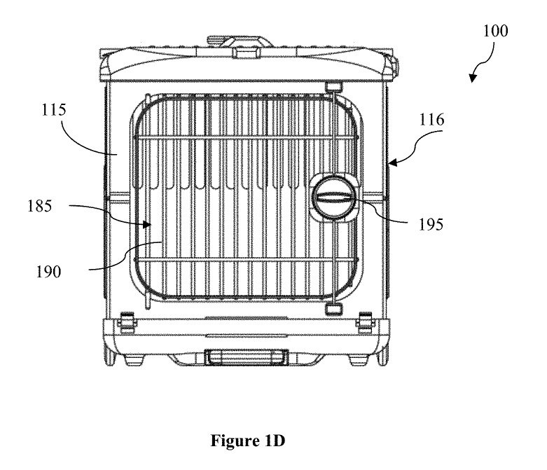

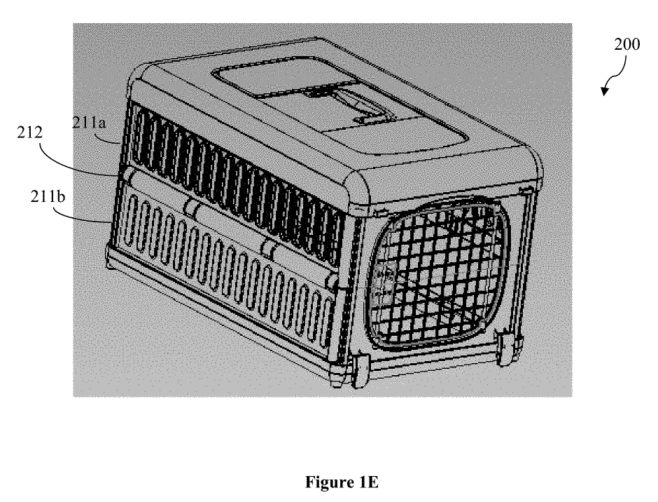

FIGS. 1A-D show one embodiment of the collapsible pet carrier 100 in an expanded configuration. FIG. 1A shows a perspective view of the collapsible pet carrier 100, FIG. 1B shows a top view of the collapsible pet carrier 100, FIGS. 1C shows a side view of the collapsible pet carrier 100. FIG. 1D shows a rear view of the collapsible pet carrier 100. The pet carrier 100 includes a top panel 105, a bottom panel 106. The top panel 105 and the bottom panel 106 are essentially parallel with each other. The pet carrier 100 also includes a right side wall 110 and a left side wall 112, which are essentially parallel with each other.

The top panel 105 and the bottom panel 106 are coupled via the right and left side walls 110, 112 along corresponding edges to form an open ended structure having a front end 116 and a back end 115. In a preferred embodiment, the pet carrier 100 further includes a front panel 117 and a back panel 118, which can at least partially, and preferably fully cover, the front end 116 and the back end 115, respectively. The front and back panels 117, 118, couple to the carrier such that the panels each pivot at an end potion of the top or bottom panel 105, 106 and are removably coupled to the bottom or top panel 106, 105, respectively. Thus, for example, where the front and back panels 117, 118, are coupled to the top panel 105, the front and back panels 117, 118 are preferably removably coupled to the bottom panel 106.

In some embodiments, the top panel 105, bottom panel 106, side walls 110, 112, front panel 117, and back panel 118 are constructed of one or more lightweight and rigid material(s). Suitable materials include polymers, composites (e.g., fiberglass, carbon fiber, etc.), and/or metals. Such rigid materials can include perforations and/or be configured as a rigid mesh or net in order to further decrease weight and improve ventilation. In some embodiments different portions of the carrier are constructed of different materials. In a preferred embodiment, materials used to construct the carrier 100 are water resistant in order to facilitate cleaning, and can incorporate bacteriostatic and/or bactericidal compounds. In other embodiments, one or more of the top panel 105, bottom panel 106, side walls 110, 112, front panel 116, and back panel 117 can include flexible materials, such as textiles and/or ne translucent or transparent. Such flexible materials can be supported by an insert, incorporated mesh, and/or frame to provide a degree of stiffness that facilitates stable folding and expansion of the carrier and to provide support for a companion animal within the carrier 100.

In a preferred embodiment, each of the right and left side walls 110, 112 include an upper side wall and a bottom side wall. For example, the right side wall 110 includes an upper right side wall 111a and a bottom right side wall 111b. Likewise, the left side wall 112 includes an upper left side wall and a bottom left side wall. The upper side wall (111a for the right side wall 110) and the bottom side wall (111b for the right side wall 110) of each of the right and left side walls 110, 112 are coupled via a hinge region 120, 121, respectively. The hinge regions 120, 121 are located horizontally across the right and left side walls 110, 112 such that they allows right and left side walls 110, 112 to fold inwardly when the carrier 100 transitions from the expanded configuration to the collapsed configuration. In a preferred embodiment, the side walls 110, 112 fold towards one another (i.e. inwardly), such that the angle between the upper and lower portions of a given side wall is less than about 45°, less than about 30°, less than about 15°, and/or less than about 10° when the carrier 100 is in the collapsed configuration As such, in the collapsed configuration, the side walls 110, 112 are folded inwardly about a central portion such that the hinge regions 120, 121 are proximal to one another, and the folded side walls 110, 112 lie between the top and bottom panels 105, 106 of the carrier 100.

Preferably, the side walls 110, 112 are perforated with a plurality of holes to facilitate ventilation of the air in and out of the carrier so that the companion animal can breathe fresh air. However, it is also contemplated that one of the side walls 110, 112 is not perforated or both of the side walls 110, 112 are not perforated. In this embodiment, at least one of the top panel 105, bottom panel 106, front panel 116, or a back panel 117 can be perforated.

In some embodiments, at least one of the side walls 110, 112 optionally includes a finger contact portion 180, which is located on the hinged regions 120, 121. In these embodiments, the user can fold the side walls 110, 112 inwardly by pushing the finger contact portion 180 inwardly or outwardly by pulling the finger contact portion 180 outwardly. Alternatively, the finger contact portion 180 can be a stabilizer to stabilize the upper side wall 111a and the bottom side wall 111 and prevent the side wall 110 from inadvertently being folded when not desired. It is also contemplated that, in some embodiments, the finger contact portion 180 can be a stabilizer to secure the pet carrier 100 in a collapsed configuration when not in use.

In some embodiments, the front and back openings 116, 115 are closed or partially closed by front and back panels 117, 118, respectively. The front and back panels 117, 118 are preferably attached along at least one edge (e.g., via a hinge, etc.) to either of the top panel 105 or the bottom panel 106 of the carrier 100. The edge can be arranged to permit the top panel 105 or the bottom panel 106 to fold flat against the interior surface of the top panel 105 or the bottom panel 106 of the carrier 100 to which it is attached when the carrier 100 is in its collapsed configuration. In a preferred embodiment, the front and back panels 117, 118 are coupled to the interior or lower surface of the top panel 105. In the expanded configuration, the front and back panels 117, 118 are rotated into an essentially vertical position that is oriented about 90° from the side walls 110, 112, providing an enclosed carrier 100. In some embodiments, it is contemplated that the front and back panels can be auto locked or latched in place once reaching a defined angle with respect to the top panel. In such embodiments, a secondary latch could be used to further secure the panel in place.

One or both of the front and back panels 117, 118 can include an opening 185 or aperture (shown in FIG. 1D) that provides an access to the interior of the pet carrier 100 when it is in the open or expanded configuration. Such an opening 185 can be restricted by including a gate, door, or similar movable barrier 190 that covers the opening 185 to an extent that prevents undesired exit of the companion animal from the carrier 100. Such a gate 190 can include a locking mechanism 195 that permits the gate to be secured or unsecured as desired. In a preferred embodiment, the locking mechanism 195 permits the gate 190 to pivot from one or more sides, and additionally permits the gate 190 to be removed from the carrier 100. This provides an unencumbered entry that can be less distressing to a pet animal being placed within the carrier 100.

In some embodiments, the top panel 105 and the bottom panel 106 includes a handle or other element(s) that enables the user to easily carry the carrier 100. Preferably, the top panel 105 includes a grabbing element (e.g., top handle 145) with which the user can grab and carry the carrier 100 in an expanded configuration. Additionally, the top panel 105 may include a side handle 140 with which the user can grab and carry the carrier 100 in a collapsed configuration. Such a handle 145 can be positioned essentially centrally on an outer surface of a top or bottom panel 105, 106. In other embodiments, the top handle 105 or a side handle 140 can be a telescoping handle 610 (as shown in FIG. 6) that is coupled to and extends along the plane of a top or bottom panel 105, 106. In such an embodiment, the telescoping handle can be extended to provide a convenient grasping point for rolling the carrier 100 in the folded/collapsed configuration and/or the unfolded/expanded configuration.

In some embodiments, in particular embodiments intended for use with medium (e.g. approximately 30 pounds) and/or large (greater than 50 pounds) companion animals, the bottom panel 106 includes a plurality of wheels 150a, 150b (or similar rolling devices) so that the user can easily drag the carrier 100. For example, a pair of wheels 150a, 150b can be arranged essentially centrally along an edge of a bottom or top panel 106, 105 of the carrier 100, which can be oriented downwards when the carrier 100 is folded or collapsed. Such wheels 150a, 150b allow the folded carrier 100 to be rolled rather than carried. In some embodiments, an additional pair of wheels can be provided along an opposing edge (or similarly, a set of four wheels arranged at each corner of a rectangular or square lower portion), permitting the carrier 100 to be rolled when in the expanded configuration. Preferably, the wheels 150a, 150b are removably coupled to the bottom panel 106, to allow removal when not needed. For example, the wheels 150a, 150b can be caster wheels that can be snap on or off from the bottom panel 106. In such embodiments, the carrier could have a recessed region or other regions where the wheels can be coupled to the carrier when not in use. Any suitable types of wheels are contemplated. In some embodiments, the wheels 150a, 150b are omni-wheel (e.g., a mecanum wheel, etc.), which enables the movement of the carrier 100 in all directions.

It is further contemplated that the carrier could have removable covers for the projection to which the wheels couple to cover the projections when not in use. Such covers could be formed of a rubber or other compound that preferably reduces a likelihood of unintentional movement or sliding of the carrier. In still other embodiments, the projections could have a spring-loaded cover that is biased downwardly or away from the bottom panel. In such embodiments, it is contemplated that coupling of the wheel to the projection causes the cover to slide upwardly or toward the bottom panel and thereby move the cover away from the projection.

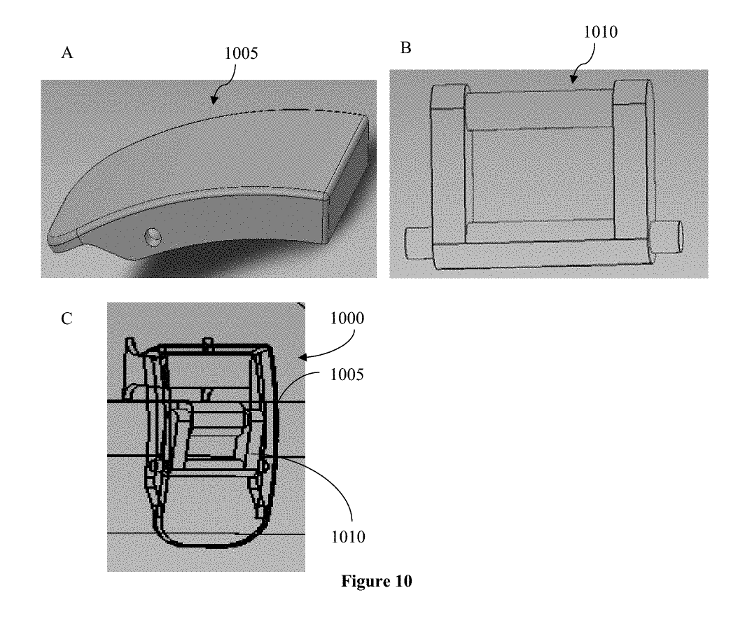

The front and back panels 117, 118 also includes one or more latch mechanisms 160a, 160b, which stabilize the front and back panels 117, 118 with the bottom panel 106. Thus, the latch mechanisms 160a, 160b, secure the carrier 100 in the expanded configuration. Such latch mechanisms 160a, 160b can engage passively on unfolding the carrier 100, but can require definitive action on the part of a user to re-fold the carrier 100. This advantageously prevents accidental folding of an unfolded or expanded carrier 100 when in use. Furthermore, it is contemplated that the latch mechanism 160a, 160b must be closed to allow for the door at the front panel 117 (or at the end portion 116) to be opened. This ensures it is properly secured before a companion animal is placed in the carrier 100. One exemplary latch mechanism 100 is shown in FIGS. 10A-C. FIG. 10A depicts an exemplary latch 1005 and FIG. 10B depicts a latch arm 1010 that can be coupled with the latch 1010. FIG. 10C illustrates the latch mechanism 1000, in which the latch 1005 and the latch arm 1010 are coupled.

FIG. 1E shows another embodiment of collapsible pet carrier 200. In this embodiment, the upper side wall 211a and bottom side wall 211b are coupled via one or more rotating hinges 212.

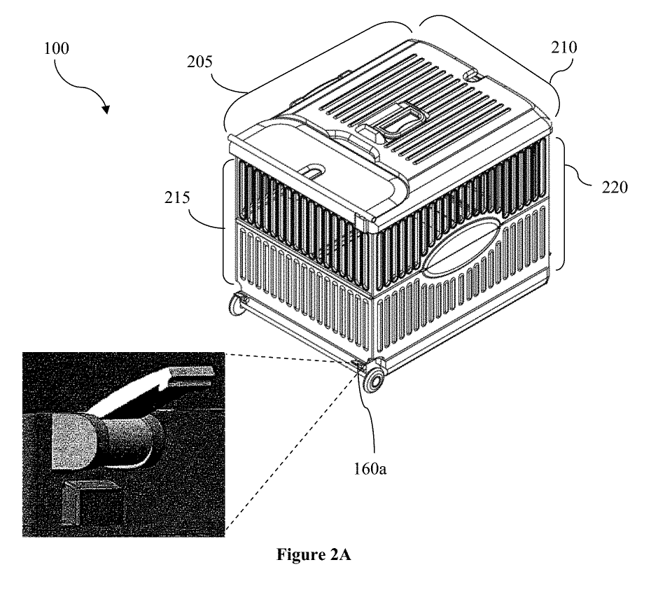

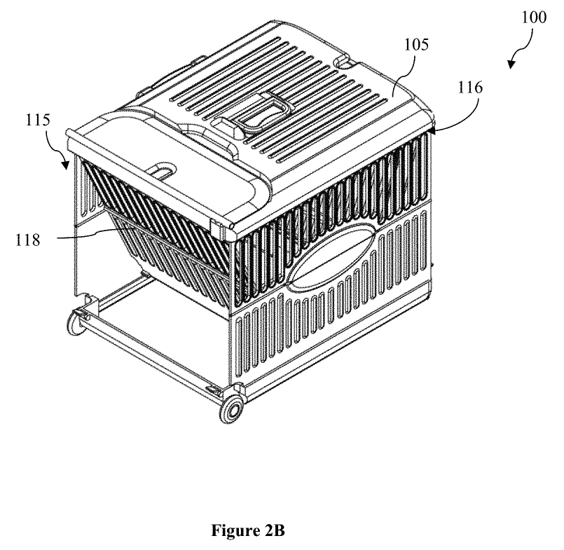

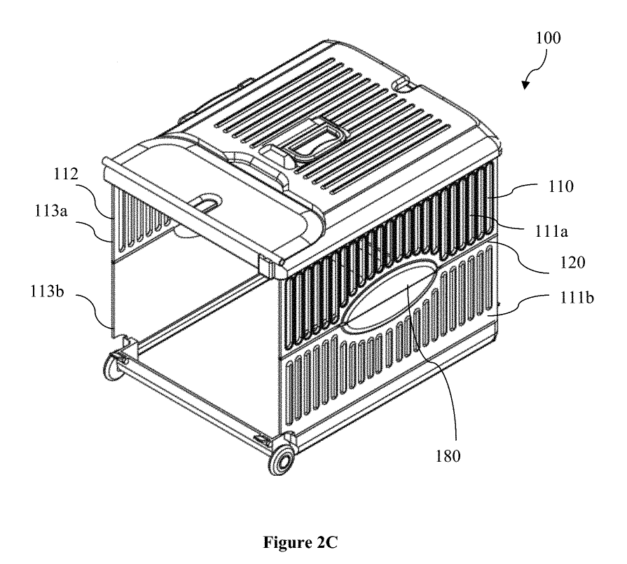

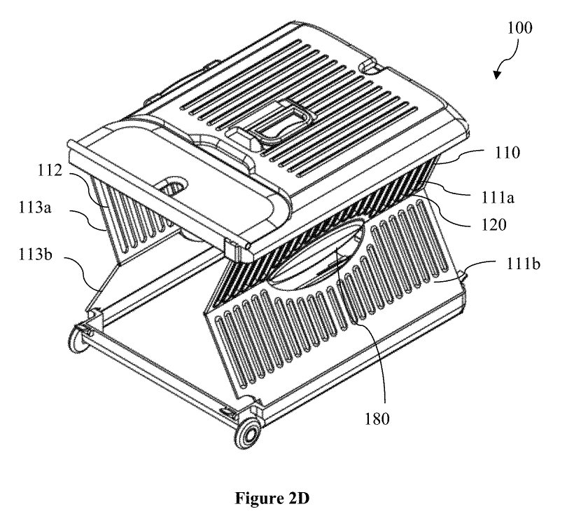

FIGS. 2A-D show the collapsible pet carrier 100 transitioning from an expanded configuration to a collapsed configuration. In the first step, the front and back panels 117, 118 are released from the bottom panel 106 or the top panel 105 such that the front and back panels 117, 118 are hingeably coupled with only one of the bottom panel 106 or the top panel 105. FIG. 2A shows one embodiment of the latch mechanism 160a, which can be lifted to unfasten the front or back panels 117, 118 from the bottom panel 106.

As shown in FIG. 2B, once the front and back panels 117, 118 are unlocked from the bottom panel 106, the front and back panels 117, 118 can be swung inwardly toward an inside surface of the top panel 105, for example.

As shown in FIG. 2C, in some embodiments, the front and back panels 117, 118 can be swung inwardly such that the front and back panels 117, 118 are planar with the top and bottom panels 105, 106. In these embodiments, at least one of top panel 105 or the bottom panel 106 are configured to receive either the front or the back panel 117, 118. It is highly preferred that the collective height 215 of the front and back panels 117, 118 is at least slightly larger (e.g., at least 0.5 inch larger, etc.) than the length 205 of the top panel such that the front and back panels 117, 118 can be folded and placed below top panel 105 without overlapping with one another. For example, if the height of front and back panels are each x, and y inches, respectively, the length z of the top panel 105 should at least 0.5 inch+x+y.

In some embodiments, It is contemplated that the inner surface of the top panel 105 to which the front and back panels 117, 118 are coupled can include one or more latches that maintains the front and back panels 117, 118 in a collapsed position until the latch(es) is actuated to release the front and back panels 117, 118. This ensures the front and back panels 117, 118 are not released from their position next to the top or bottom panel 105, 106 until desired. Such latches may be released using an actuator disposed on the top panel for example.

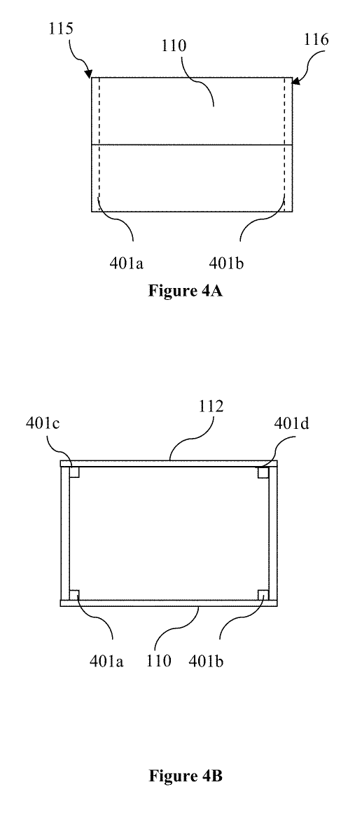

Alternatively or additionally, movement of the front and back ends 115, 116 to the expanded configuration can act to prevent collapse of the sidewalls and thereby stabilize them. In one contemplated embodiment shown in FIGS. 4A-B, the front and back ends 115, 116 can include one or more projections 401a, 401b, 401c, 401d on either side of the end portions 115, 116 that are adjacent to the sidewalls 110, 112. FIG. 4A shows a side view of the carrier 100 showing the projections 401a, 401b, (dotted lines), vertically placed along the front and back ends 115, 116. FIG. 4B shows a top view of the carrier 100 showing the four projections 401a, 401b, 401c, 401d in each corner where the side walls 110, 112 meets front and back ends 115, 116. The one or more projections 401a, 401b, 401c, 401d advantageously block the sidewalls 110, 112 from folding inwardly and thereby prevent their collapse. Critically, the projections 401a, 401b, 401c, 401d should be at least placed at the portion of the sidewalls 110, 112 comprising the hinge, but additional projections can add further stability to the sidewalls 110, 112.

As shown in FIG. 2D, once the front and back panels 117, 118a are fully moved toward the inner surface of the top panel 105, the side walls 110, 112 folded at the hinge regions 120, 121, so that the upper and the bottom side walls 111a, 111b, 113a, 113b are planar with the top and bottom panels 105, 106. Thus, in these embodiments, it is highly preferred that the depth 210 of the top panel 105 or the bottom panel 106 are same or larger (e.g., at least 0.5 inch larger, etc.) the combined heights of the upper side walls 111a, 113b are shorter than so that the top side walls 111a, 113a can be placed below top panel 105 (near the inner surface of the top panel 105) without getting overlapped with each other, and the bottom side walls 111b, 113b can be placed on the bottom panel 106 without getting overlapped with each other.

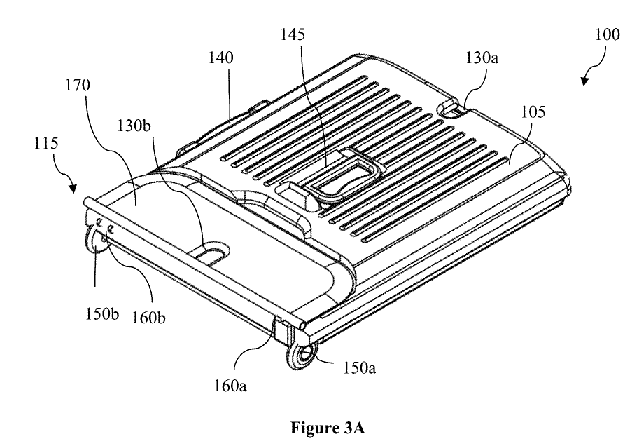

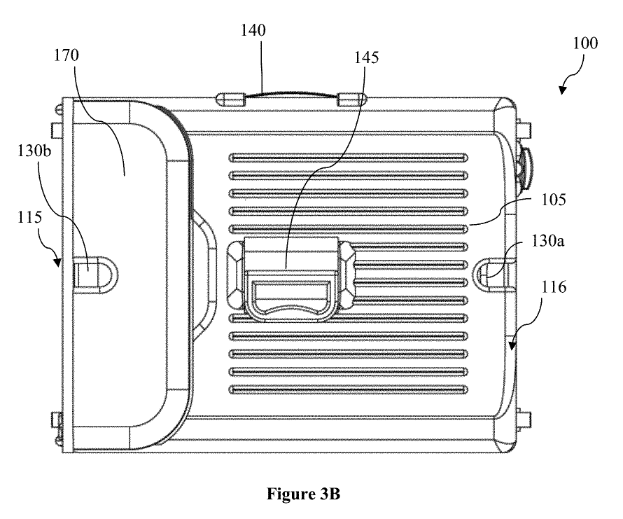

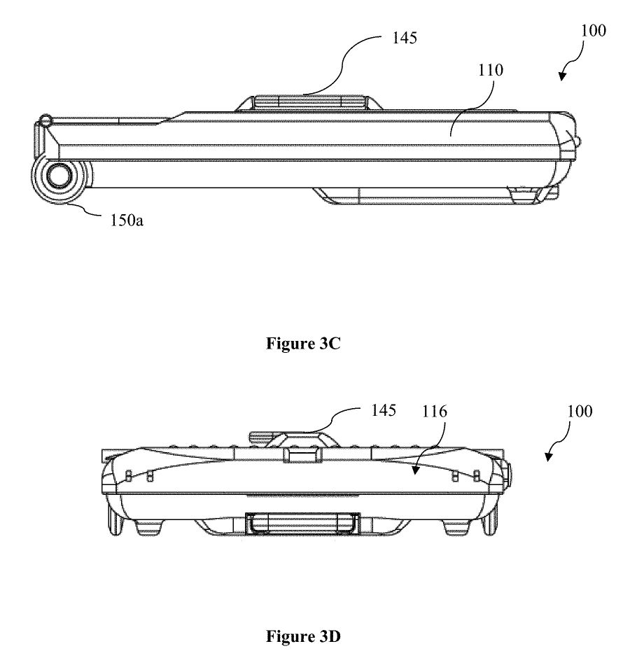

FIGS. 3A-3D show the collapsible pet carrier 100 in an collapsed configuration. FIG. 3A shows a perspective view of the collapsible pet carrier 100, FIG. 3B shows a top view of the collapsible pet carrier 100, FIGS. 3C shows a side view of the collapsible pet carrier 100. FIG. 3D shows a rear view of the collapsed pet carrier 100.

In some embodiments, at least one of the top panel 105 or the bottom panel 106 includes one or more finger insert apertures 130a, 130b, through which the user can insert the user's fingers (or other objects) to push the front or back panels 117, 118 away from the inner surface of the top panel 105. It is also contemplated that the top panel 105 includes an additional finger insert aperture, through which the user can insert the user's fingers (or other objects) to apply manual pressure (e.g., push) the side walls 110, 112 away from inner surface of the top panel 105. This facilitates opening and/or expansion of the folded carrier 100 with minimal risk of injury due to pinching of the hand by or between carrier components, while also providing an additional ventilations hole when in the expanded position. In a preferred embodiment, such an aperture is located along the periphery or edge of either or both of the top panel 105 and the bottom panel 106. Such an aperture can, for example, be an elongated opening measure approximately 1 inch to 2 inches in width and 3 to 6 inches in length, and can include a reinforced edge to provide leverage.

In some embodiments, the carrier 100 includes a locking or latch mechanism that prevents easy escape of the companion pets from the carrier 100. As noted above, a carrier 100 of the inventive concept can be in a folded or collapsed configuration or in an expanded or open configuration. Either or both of these configurations can be stabilized by latches or similar mechanisms that serve to stabilize or temporarily lock adjacent portions of the carrier to one another. In a preferred embodiment, such latches are activated (e.g., locked) by the act of opening or expanding the carrier 100 without additional action on the part of the user. For example, the act of unfolding the side walls can trigger a latch that automatically locks the side walls into an extended position where the panels of the side wall are at an angle of approximately 180° relative to one another to provide essentially planar sidewalls. Similar latch mechanisms can serve to stabilize the angle between the top panel and the side walls and between the bottom panel and side walls at about 90° on unfolding of the side walls. This advantageously stabilizes the carrier in the open or expanded configuration when in use without a need on the part of the user to manually trigger numerous latches, and serves to improve the safety of the companion animal by insuring that the open or expanded configuration is stabilized. Such latches can be configured to be released by a triggering mechanism (e.g., movement of a pin, button, collar, sleeve, or latch) in order to release the latch and permit transition of the carrier to the closed or collapsed configuration.

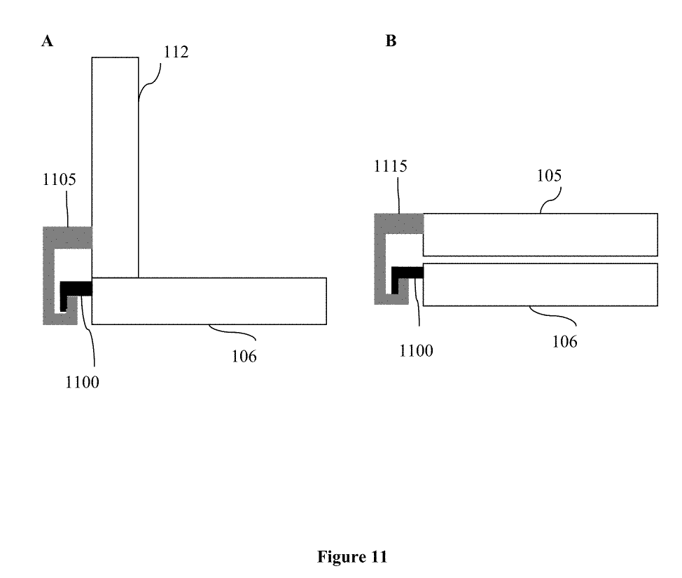

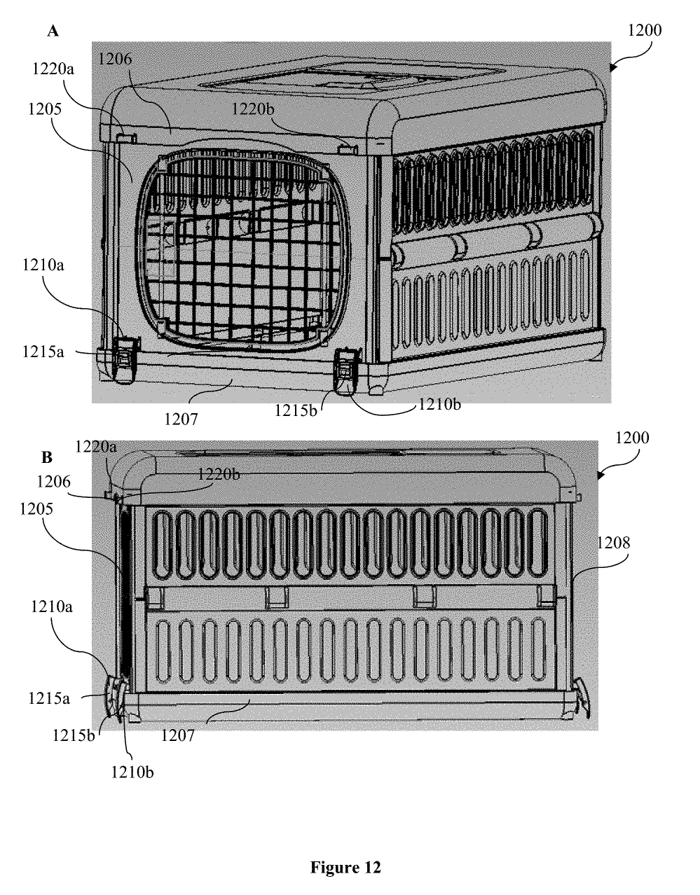

In some embodiments, the latch mechanism can be a coupling of a projection in the bottom panel and a latch in the side wall or a top panel. FIGS. 11A-B illustrate such example. In this example, as shown in FIG. 11A, the bottom panel 106 is coupled with a projection 1100 and the side wall 112 is coupled with a latch 1105. The latch 105 and the projection 1100 can be coupled when the angle between the top panel 105 and the side wall 112 and between the bottom panel 106 and side wall 112 are at about 90° to lock and stabilize the carrier 100 in an expanded configuration. In some embodiments, as shown in FIG. 11B, the bottom panel 106 is coupled with a projection 1100 and the top panel 105 is coupled with a latch 1105. The latch 105 and the projection 1100 can be coupled when the side wall 112 is substantially planar with the top panel 105 and/or a bottom panel 106 to lock and stabilize the carrier 100 in a collapsed configuration.

FIGS. 12A-B illustrate another embodiment of the collapsible pet carrier 1200 including latching systems comprising one or more fixed projections attached to the carrier and one or more movable latches each configured to couple with one or more of the fixed projection, somewhat similar to those described in FIGS. 11A-B. FIG. 12A shows a perspective view of the carrier 1200, and FIG. 12B shows a side view of the carrier 1200. In this embodiment, both top panel 1206 and front panel 1205 includes projections 1220a-1220b and 1215a-1215b, respectively, and the bottom panel 1207 includes latches 1210a, 1210b. The opposite side (e.g., side with back panel 1208) may comprise a similar latching system of projections and latches.

In some embodiments, only one side of the bottom panel 1207 includes latches, and only one side of the top panel 1206 and the front panel 1205 include projections (e.g., either front end or the back end of the carrier). In preferred embodiments, both sides of the back panel 1208 include latches and both sides of the top panel 1206 (e.g., front and back ends), as well as the front panel 1207 and back panel 1208, include projections. It is further contemplated that each of the front and back sides of the carrier could have a single latch, with a projection disposed on each side of the top panel 1206 and a projection disposed on each of the front panel 1205 and back panel 1208.

In an expanded configuration, the latches 1210a, 1210b are coupled with the projections 1215a, 1215b of the front panel 1205 (and latches may be coupled with projections of the back panel 1208), such that the front panel 1205 (and preferably back panel 1208) are positioned and secured substantially at a perpendicular angle (e.g., a 90 degree angle with respect to the top panel). In a collapsed configuration, the latches 1210a, 1210b are coupled with the projections 1220a, 1220b of the top panel 1206 respectively (and latches may be coupled with projections on the opposite side of the top panel 1206), such that the top panel 1206 and the bottom panel 1207 are closely positioned with each other and secured in the collapsed configuration.

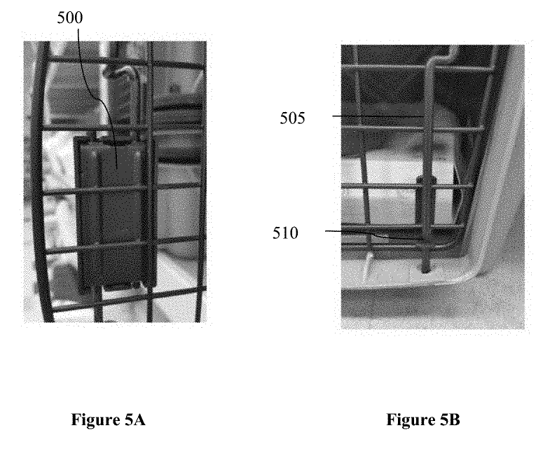

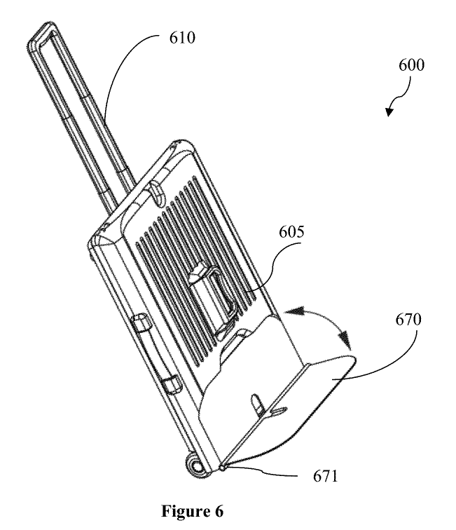

FIGS. 5A-B show one example of the locking mechanism that includes a body 500 and a shaft 505 that is extended from the body and coupled with a hole 510. In order to unfasten this locking mechanism, a portion of the shaft 505 should be squeezed and then lifted from the hole 510.

As shown in FIG. 6, in some embodiments the carrier 600 can include a dolly panel 670 (170 in FIGS. 1A-3D) that is coupled to the top panel 605 with a hinge 671 that permits it to rotate away from the carrier 600 to an angle of approximately 90° or more. When rotated or extended is such a fashion the dolly panel 670 can advantageously serve as a support and/or platform for additional items (e.g., luggage, pet supplies, etc.) when used in conjunction with the extendable handle 610 on a wheel-bearing carrier 600, permitting the folded carrier 600 to act as a hand cart. Preferably, the dolly panel comprises an aperture that aligns with the aperture 130b on the top panel to allow a user to push down on the front or back panel to facilitate unfolding of the carrier.

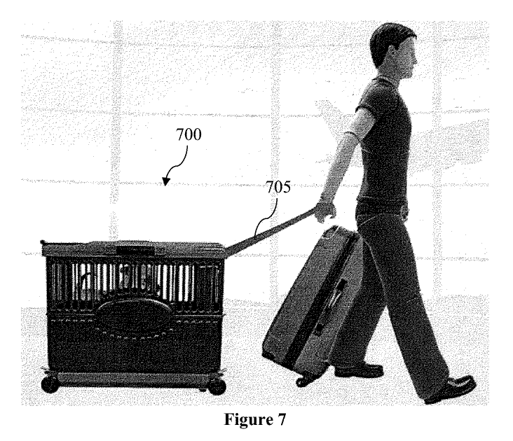

In some embodiments the carrier can be coupled with a removable strap. Such a strap can include features such as buckles for interfacing with safety equipment, clips and/or rings that serve as points of attachment, sliding mechanisms for adjusting length, and/or pads or supports that serve to distribute weight across the body of a person transporting the carrier when folded. In some embodiments such a strap can be used to secure the carrier for travel when in the expanded or open configuration. For example, as shown in FIG. 7, a strap 705 can be coupled with a wheeled carrier 700 so that a user can roll the wheeled carrier 700 by pulling the strap 705. In some embodiments, the strap 705 is coupled with a handle so that the user can grab the handle to pull the strap 705.

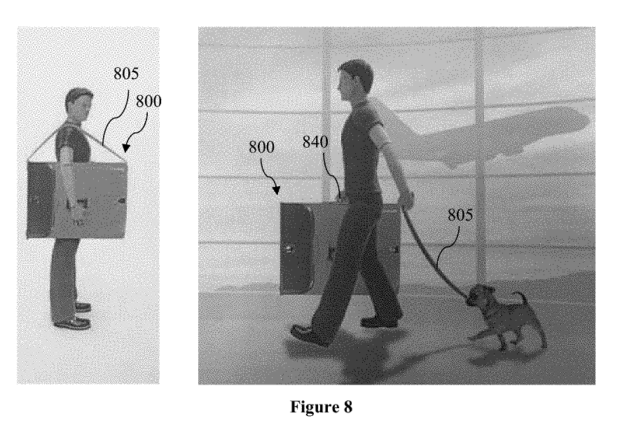

FIG. 8 shows another embodiment of the removable strap 805 coupled with the carrier 800. In this embodiment, the removable strap 805 is coupled with at least two corners of the carrier 800 (e.g., two ends of the side walls, two ends of the top panel or the bottom panel) such that the user can use the removable strap 805 as a shoulder strap to carry the carrier 800 on the user's shoulder. In this embodiment, it is also contemplated that the removable strap 805 can be used as a leash for the pet while the user can carry the carrier 800 using a side handle 840. It is further contemplated that the removable strap 805 is coupled with a clip that can function to attach the strap to a pet's collar as well as to a LATCH (lower anchors and tethers for children) system of a vehicle. Similarly, in some embodiments the strap can be configured as a collar or harness for a companion animal.

In some embodiments, the top panel, bottom panel, and/or side walls can include opening or passages that are dimensioned to permit passage of the strap or a seat belt of a vehicle, and placed to allow the strap to at least partially surround the carrier when it is in the open or expanded configuration. In such an embodiment, the strap can include one or more buckles that can couple with safety equipment (for example, a safety belt or child seat anchoring system of an automobile), permitting the carrier to be safely secured within a vehicle when transporting a companion animal. In still other embodiments the strap can include devices that permit self-attachment, and have sufficient length to extend around the carrier when it is in a folded/collapsed configuration and/or an open/expanded configuration. In such an embodiment the strap can be secured around the carrier in order to stabilize the configuration (e.g. preventing a folded carrier from opening). In still other embodiments the strap can include a cushion, pad, or similar weight distributing feature, and be coupled to opposing ends of the carrier when the carrier is in a folded or collapsed state. Such a strap can facilitate transport of the carrier by an individual, who can position the cushion or pad on their shoulder to lift the carrier and walk essentially normally.

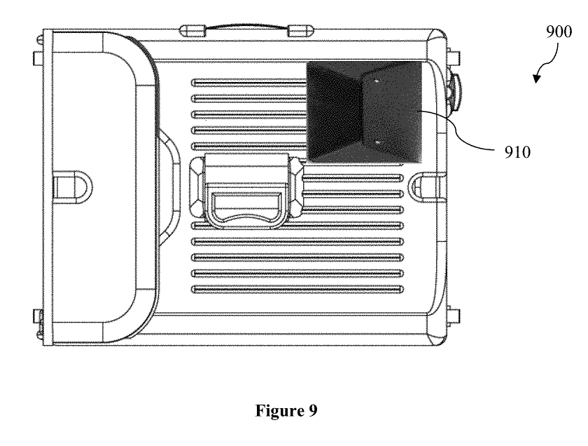

In some embodiments, as shown in FIG. 9, the carrier 900 can include an accessory pouch or bag 910, which can be coupled to or incorporated into an exterior surface of the carrier 900. Such an exterior pouch 905 can include animal supplies, for example one or more collapsible bowls, food, medication, and waste disposal bags. In some embodiments such a collapsible bowl can be coupled to a mating feature on the interior surface of the bottom panel of the carrier.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A collapsible pet carrier, comprising:
a top panel;
a bottom panel coupled to the top panel by first and second sidewalls;
wherein the first side wall comprises a first edge coupled to the top panel, a second edge coupled to the bottom panel, a third edge that is parallel to the first edge, a fourth edge that opposes the third edge, and a first hinge region interposed between the third and fourth edges;
wherein the second side wall comprises a fifth edge coupled to the top panel, a sixth edge coupled to the bottom panel, a seventh edge that is parallel to the fifth edge, an eighth edge that opposes the seventh edge, and a second hinge region interposed between the seventh and eighth edges, wherein the second sidewall opposes the first sidewall, and wherein the top and bottom panels and the first and second sidewalls collectively define a primary structure comprising a first end and a second end;
a first end portion comprising an aperture and a barrier configured to reversibly cover the aperture, wherein the first end portion is positionable at the first end;
a second end portion positionable at the second end, wherein the first and second end portions are each pivotally coupled to the top or bottom panel; and
wherein the pet carrier has an expanded configuration wherein first hinge region is positioned at an essentially 180° angle such that the first side wall portion is essentially planar, the second hinge region is positioned at an essentially 180° angle such that the second side wall portion is essentially planar, the first end portion is positioned over the first end, and the second end portion is positioned over the second end, and
wherein the pet carrier portion has a collapsed configuration wherein first hinge region is positioned at an angle of less than 30° such that the first hinge region subtends towards the second side wall, the second hinge region is position at an angle of less than 30° such that the second hinge region subtends towards the first side wall, and the first end portion and second end portion are approximately parallel to and interposed between the first horizontal portion and the second horizontal portion.

2. The pet carrier of claim 1, wherein the top panel comprises an access hole proximal to a periphery of the top panel, and wherein the access hole is dimensioned and positioned on the top panel to permit a user to contact and apply manual pressure to one of the first sidewall and the second sidewall when the pet carrier is in the collapsed configuration, so as the assist in transitioning between the collapsed configuration and the expanded configuration.

3. The pet carrier of claim 1, further comprising a pair of wheels affixed to the bottom panel.

4. The pet carrier of claim 3, further comprising an extendable handle.

5. The pet carrier of claim 4, further comprising a dolly platform rotatably coupled along an edge to the top panel.

6. The pet carrier of claim 5, wherein the dolly platform is positioned to provide a support surface when the extendable handle is extended from the pet carrier when the pet carrier is in the collapsed configuration.

7. The pet carrier of claim 2, further comprising a dolly platform rotatably coupled along an edge to the top panel, and wherein the dolly platform comprises an aperture that aligns with the access hole of the top panel.

8. The pet carrier of claim 1, wherein the barrier of the first end portion comprises a latch, and wherein the latch is configured to permit both pivoting of the barrier relative to the first end portion and removal of the barrier from the first end portion.

9. The pet carrier of claim 1, further comprising a removable strap.

10. The pet carrier of claim 9, wherein the first horizontal portion further comprises a strap aperture dimensioned to permit passage of the strap, wherein the strap aperture is positioned to facilitate coupling of the strap to an automobile interior surface.

11. The pet carrier of claim 9, wherein the strap includes a shoulder pad, and is coupled to opposing edges of one of the first horizontal portion and the second horizontal portion so as to facilitate carrying of the pet carrier by a user when the pet carrier is in the collapsed configuration.

12. The pet carrier of claim 9, wherein the strap further comprises a clip and a length adjuster, and wherein the clip is configured to attach to (1) a collar or harness, and (2) an anchor of a lower anchor and tethers for Children (LATCH) restraint system.

13. The pet carrier of claim 9, wherein the strap is dimensioned to extend around the pet carrier when it is the collapsed configuration so as to stabilize the collapsed configuration.

14. The pet carrier of claim 1, wherein the first horizontal portion, the second horizontal portion, the first side portion, and the second side portion are constructed of a rigid material.

15. The pet carrier of claim 1, further comprising an accessory bag.

16. The pet carrier of claim 15, wherein the accessory bag comprises a collapsible pet bowl.

17. The pet carrier of claim 1, wherein the first side portion comprises a first latch, wherein the latch is configured to stabilize the first hinge region at the approximately 180° angle on transitioning from the collapsed configuration to the expanded configuration.

18. The pet carrier of claim 1, wherein the first side portion comprises a second latch proximal to the first horizontal portion, wherein the second latch having a first position and a second position, wherein the second latch is configured to maintain the first horizontal portion normal to the first side portion when in the first position and to permit rotation of the first horizontal portion relative to the first side portion when in the second position.

19. The pet carrier of claim 1, wherein the first side portion comprises a third latch proximal to the second horizontal portion, wherein the third latch having a first position and a second position, wherein the third latch is configured to maintain the second horizontal portion normal to the first side portion when in the first position and to permit rotation of the second horizontal portion relative to the first side portion when in the second position.

20. The pet carrier of claim 1, further comprising:
first and second latches outwardly extending from first and second sides of the bottom panel, respectively;
wherein the first end portion comprise a first projection, the second end portion comprises a second projection, and the top panel comprises third and fourth projections disposed on the first and second sides of the top panel, respectively;
wherein the first latch is configured to couple with the first projection, and the second latch is configured to couple with the second projection, to secure the first end portion and the second end portion in a substantially upright position; and
wherein the first latch is configured to couple with the third projection, and the second latch is configured to couple with the fourth projection, to secure the first end portion and the second end portion in a substantially parallel position with respect to the top panel.
